(19) United States
(12) Patent Application Publication
(10) Pub. No.: US 2020/0394356 A1
(43) Pub. Date: Dec. 17, 2020

(54) TEXT INFORMATION PROCESSING METHOD, DEVICE AND TERMINAL

(71) Applicant: Beijing Dajia Internet Information Technology Co., Ltd., Beijing (CN)

(72) Inventors: Zhiwei Zhang, Beijing (CN); Fan Yang, Beijing (CN)

(73) Assignee: Beijing Dajia Internet Information Technology Co., Ltd., Beijing (CN)

(21) Appl. No.: 17/004,720

(22) Filed: Aug. 27, 2020

Related U.S. Application Data
(63) Continuation of application No. PCT/CN2018/122698, filed on Dec. 21, 2018.

(30) Foreign Application Priority Data
Feb. 27, 2018 (CN) 201810162656.1

(51) Int. Cl. G06F 40/129; G06F 40/242; G06F 40/284; G06N 3/04; H04L 9/06

(52) U.S. Cl. CPC G06F 40/129; G06F 40/242; H04L 9/0643; G06N 3/04; G06F 40/284

(57) ABSTRACT

A text information processing method, device and terminal, wherein the method comprises: determining a pinyin character string corresponding to text information; using an N-tuple algorithm to convert the pinyin character string into a string set that comprises a plurality of character string elements; determining an index and the occurrence number, in a total string set, of each character string element in the string set; generating a pinyin hash vector corresponding to the text information according to the index and occurrence number corresponding to each character string element; and processing the pinyin hash vector by means of an embedded neural network to obtain continuous features corresponding to the text information.

### CROSS-REFERENCE TO RELATED APPLICATIONS

This application is a continuation of International Application No. PCT/CN2018/122698, filed on Dec. 21, 2018, which claims priority of the Chinese Patent Application 201810162656.1, filed to the China National Intellectual Property Administration on Feb. 27, 2018 and entitled “TEXT INFORMATION PROCESSING METHOD, DEVICE AND TERMINAL”, the entire contents of which are incorporated herein by reference.

### FIELD

This application relates to the technical field of text information processing and in particular to a text information processing method, device and terminal.

### BACKGROUND

Recently, deep learning has been widely applied in fields related to natural language processing, text translation, etc. When text information is processed, discrete data such as a text is required to be converted into continuous features, which may be input to a deep neural network, under most conditions.

### SUMMARY

One aspect of this disclosure provides a method for processing text information, wherein the method includes: determining a first pinyin string corresponding to text information; determining a first string set based on the first pinyin string, wherein the first string set comprises a plurality of first string elements; determining an index and an occurrence number of each first string element in a total string set; generating a pinyin hash vector based on the index and the occurrence number; and determining continuous features of the text information based on the pinyin hash vector and an embedded neural network.

In some embodiments, the determining the first string set, includes: determining the first string set by using a sliding window algorithm based on the first pinyin string, wherein the sliding window algorithm comprises a preset step length and a window size.

In some embodiments, the method further includes: determining second pinyin strings of words in the dictionary; generating a second string element by adding placeholders before and after a second pinyin string for each of the words respectively; determining a second string set based on the second string element; and generating the total string set by uniting second string sets.

In some embodiments, the generating a pinyin hash vector, includes: generating a zero vector, wherein a dimension of the zero vector is equal to that of the total string set; determining a dimension of the index in the zero vector; generating the pinyin hash vector by adjusting a numerical value of the dimension as the occurrence number.

Another aspect of this disclosure provides a terminal including a memory, a processor and a program for processing text information, wherein the program is stored on the memory, the processor is configured to execute the program to implement followings: determining a first pinyin string corresponding to text information; determining a first string set based on the first pinyin string, wherein the first string set comprises a plurality of first string elements; determining an index and an occurrence number, in a total string set, of each first string element; generating a pinyin hash vector based on the index and the occurrence number; and determining continuous features of the text information based on the pinyin hash vector and an embedded neural network.

In some embodiments, the processor is configured to execute the program to determine the first string set by: determining the first string set by using a sliding window algorithm based on the first pinyin string, wherein the sliding window algorithm comprises a preset step length and a window size.

In some embodiments, the processor is configured to execute the program to generate the total string set by: determining second pinyin strings of words in a dictionary; generating a second string element by adding placeholders before and after a second pinyin string for each of the words respectively; determining a second string set based on the second string element; and generating the total string set by uniting second string sets.

In some embodiments, the processor is configured to execute the program to generate a pinyin hash vector by: generating a zero vector, wherein a dimension of the zero vector is equal to that of the total string set, determining a dimension, in the zero vector, of the index, generating the pinyin hash vector by adjusting a numerical value of the dimension as the occurrence number.

Yet further aspect of this disclosure provides a computer readable storage medium, the computer readable storage medium stores a program for processing text information, the program including sets of instructions for: determining a first pinyin string corresponding to text information; determining a first string set based on the first pinyin string, wherein the first string set comprises a plurality of first string elements; determining an index and an occurrence number of each first string element in a total string set; generating a pinyin hash vector based on the index and the occurrence number; and determining continuous features of the text information based on the pinyin hash vector and an embedded neural network.

In some embodiments, the determining the first string set, includes: determining the first string set by using a sliding window algorithm based on the first pinyin string, wherein the sliding window algorithm comprises a preset step length and a window size.

In some embodiments, the program further includes a set of instructions for:

determining second pinyin strings of words in a dictionary; generating a second string element by adding placeholders before and after a second pinyin string for each of the words respectively; determining a second string set based on the second string element; and generating the total string set by uniting second string sets.

In some embodiments, the generating a pinyin hash vector, includes: generating a zero vector, wherein a dimension of the zero vector is equal to that of the total string set; determining a dimension of the index in the zero vector; generating the pinyin hash vector by adjusting a numerical value of the dimension as the occurrence number.

### BRIEF DESCRIPTION OF THE DRAWINGS

The above and/or appended aspects and advantages of this disclosure will become apparent and easily understandable in the description of embodiments in combination with accompanying drawings.

FIG. 1 is a flow diagram of steps of a text information processing method according to the first embodiment of this disclosure;

FIG. 2 is a flow diagram of steps of a text information processing method according to the second embodiment of this disclosure;

FIG. 3 is a structural block diagram of a text information processing device according to the third embodiment of this disclosure; and

FIG. 4 is a structural block diagram of a terminal according to the fourth embodiment of this disclosure.

### DETAILED DESCRIPTION OF THE EMBODIMENTS

### First Embodiment

Referring to FIG. 1, a flow diagram of steps of a text information processing method according to the first embodiment of this disclosure is shown.

The text information processing method according to some embodiments of this disclosure can be implemented by a terminal, such as a smart phone, and may include the following steps:

step 101: determining a pinyin string corresponding to text information. The pinyin is the standard system of romanized spelling for transliterating Chinese.

The text information may be a word or a text including a plurality of words. It should be noted that the word is not specifically limited in some embodiments of this disclosure, and all words which may be converted into pinyin strings may be the words in embodiments of this disclosure, for example, the word may be a Chinese character. Moreover, the number of words included in the word is not specifically limited in embodiments of this disclosure.

When the text information includes a plurality of words, the adjacent words may be separated by a blank space, and placeholders are respectively added before and after each of the words, wherein the placeholders may be “#”, of course, the placeholders are not limited to “#”, and any other appropriate symbols may also be used as the placeholders.

In order to clearly describe the solution, an example in which the text information is a word is described in embodiments of this disclosure. For example, the text information is “ [symbol] ”, the pinyin string corresponding to the text information may be “#zhongguo#”.

It may be understood by those skilled in the art that a specific way for converting the text information into the pinyin string refers to the related art, the descriptions thereof are omitted in embodiments of this disclosure.

Step 102: converting the pinyin string into a string set that includes a plurality of character string elements based on an N-tuple algorithm.

The N-tuple algorithm is an N-gram algorithm by which the pinyin string may be converted into a plurality of sub character strings in a sliding window way, and the number of characters of each sub character string is less than the number of characters of the pinyin string. The step length and window size of a sliding window may be set in advance, and the window size of the sliding window may be the length and width of the window. After the pinyin string is divided into the plurality of sub character strings, the string set composed of the plurality of character string elements may be obtained, and each sub character string is one character string element in the string set.

In order to guarantee the completeness and clear description of the solution, a specific implementation way that the N-tuple algorithm is used to convert the pinyin string into the string set that includes the plurality of character string elements will be described in detail in the second embodiment.

Step 103: determining an index and an occurrence number, in a total string set, of each character string element in the string set.

A formation process of the total string set may be: determining pinyin strings corresponding to various words in the dictionary, using an N-gram algorithm to convert the pinyin strings corresponding to various words in the dictionary into a total string set that includes a plurality of character string elements. It can be understood that each character string element in the total string set corresponds to one index in the total string set.

The pinyin string corresponding to the text information has been converted into the plurality of character string elements in step 102 in which the index and occurrence number, in the total string set, of each character string element obtained by conversion are required to be determined. The index, in the total string set, of each character string element may be the row and column, located in the total string set, of each character string element. The occurrence number, in the total string set, of each character string element may be the total occurrence number, in the total string set, of each character string element. For example, if one of the character string elements obtained by conversion is “zho”, the index corresponding to the character string element in the total string set, namely the specific row and column, located in the total string set, of the character string element, is inquired, and then, the occurrence number, in the total string set, of the character string element is counted.

Step 104: generating a pinyin hash vector corresponding to the text information based on the index and occurrence number corresponding to each character string element.

The pinyin hash vector includes multiple dimensions, each dimension corresponds to one index, and each index corresponds to one character string element. After the index and occurrence number corresponding to a certain character string element are determined, the dimension corresponding to the index is determined, and the numerical value of the dimension is set as the occurrence number. For the dimension corresponding to the index of the character string element with the occurrence number being 0, the numerical value of the dimension is set as 0, and finally, the pinyin hash vector is generated.

Step 105: obtaining continuous features corresponding to the text information based on the pinyin hash vector and an embedded neural network.

The dimension of data in the embedded neural network is relatively low, and a discrete sequence may be mapped into a continuous vector. Therefore, the continuous features corresponding to the text information may be obtained by processing the pinyin hash vector by means of the embedded neural network. It can be understood by those skilled in the art that a specific processing way that the pinyin hash vector is processed by means of the embedded neural network to obtain the continuous features corresponding to the text information refers to the related art, the descriptions thereof are omitted in embodiments of this disclosure.

According to the text information processing method provided by the embodiment of this disclosure, the words in the dictionary are converted into the pinyin strings, and the N-tuple algorithm is used to process the pinyin strings to obtain a pinyin hash space corresponding to the total string set. Then, the text information is converted into the pinyin string, the pinyin hash vector corresponding to the pinyin string is determined based on the constructed pinyin hash space, and finally, the determined pinyin hash vector is processed by means of the embedded neural network to obtain the continuous features corresponding to the text information. Since the pinyin hash space is adopted to characterize the words in the dictionary in the embodiment of this disclosure, there is good robustness for words that do not appear in the dictionary; in addition, since the size of the pinyin hash space is constant, an overall structure of the constructed pinyin hash space may not be affected even if words are newly added in the dictionary, pinyin string sets corresponding to the newly added words are only required to be added, and therefore, strong expandability is achieved.

### Second Embodiment

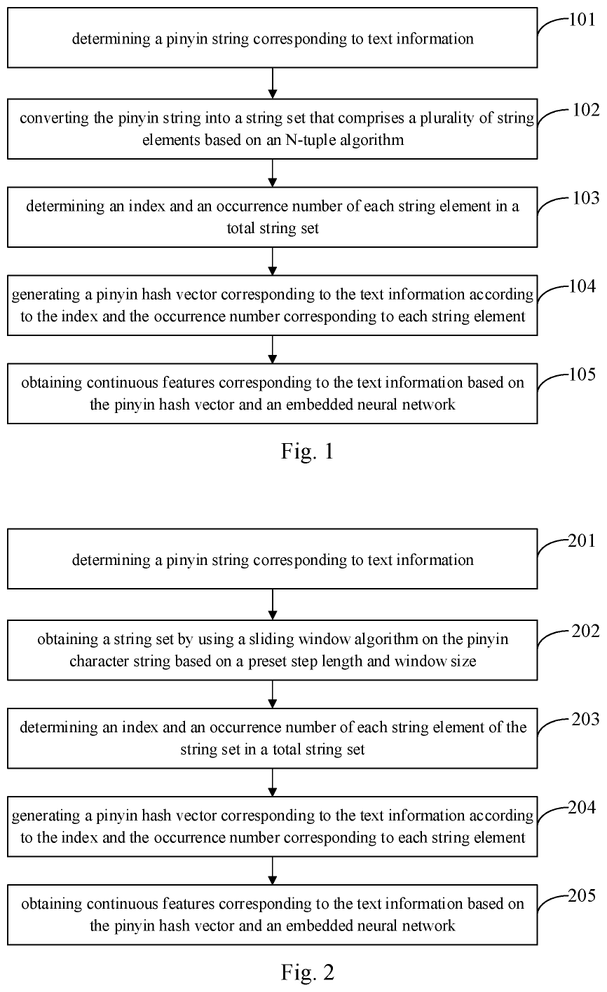

Referring to FIG. 2, a flow diagram of steps of a text information processing method according to the second embodiment of this disclosure is shown.

The method for processing text information according to some embodiments of this disclosure can be implemented by a terminal, such as a smart phone, and may include the following steps.

Step 201: determining a pinyin string corresponding to text information.

The text information may be a word or a text including a plurality of words. It should be noted that the word is not specifically limited in embodiments of this disclosure, and all words which may be converted into pinyin strings may be the words in embodiments of this disclosure, for example, the word may be a Chinese character. Moreover, the number of words included in the word is not specifically limited in embodiments of this disclosure.

When the text information includes a plurality of words, the adjacent words may be separated by a blank space, and placeholders are respectively added before and after each of the words, wherein the placeholders may be “#”, of course, the placeholders are not limited to “#”, and any other appropriate symbols may also be used as the placeholders. For example, if the text information is “ [symbol] ”, the converted pinyin string is “#dongwu#”.

Step 202: obtaining a string set that includes a plurality of character string elements, by using a sliding window algorithm on the pinyin string based on a preset step length and window size.

A specific numerical value of the preset step length may be set by those skilled in the art according to an actual demand, but is not specifically limited in some embodiments of this disclosure. For example, the preset step length may be set to be 1 character, 2 characters or 3 characters. The window size may be adaptively adjusted by those skilled in the art according to an actual demand, for example, the window size may be set to be 2, 3 or 4 and the like. For example, if the preset step length is 1 and the window size is 3, the string set obtained is as follows: {‘#do’‘don’‘ong’‘ngw’‘gwu’‘wu#’} after performing the sliding window algorithm on the pinyin string which is “#dongwu#”.

Step 203: determining an index and the occurrence number, in a total string set, of each character string element in the string set.

In some embodiments, the total string set is generated based on a dictionary, wherein the dictionary comprises a plurality of words. In some embodiments, generating the total string comprising steps as follows.

First, determining pinyin strings of words in the dictionary.

Second, generating a string element by adding placeholders before and after a pinyin string for each of the words respectively.

The string elements corresponding to the words may form a first string set, in other words, the first string set includes the generated string elements corresponding to the words.

In some embodiments, for a word set Sh in the dictionary, all words in the set Sh are converted into pinyin strings, adjacent words are separated by the blank space, and placeholders “#” are respectively added before and after each of the words to obtain a word-Chinese pinyin set Sp, namely the first string set.

Third, for each string element in the first string set, converting the string element into a second string set that includes a plurality of string elements.

When the N-tuple algorithm is used to convert the character string element into the second string set that includes the plurality of character string elements, the preset step length and window size required during sliding window processing may be set by those skilled in the art according to an actual demand. For example, one word in the dictionary is “ [symbol] ” which is converted into the pinyin string “#zhongguo#”. The N-gram algorithm is that, sliding window processing is performed on the pinyin string with the window size being 3 characters and the step length being 1 character from the first character of the pinyin string to obtain a set Sw, namely the second string set. Sw={‘#zh’‘zho’‘hon’‘ong’‘ngg’‘ggu’‘guo’‘uo#’}.

The pinyin strings in Sp are processed to obtain the second string set Sw corresponding to various pinyin strings.

Finally, obtaining the total string set by uniting the second string sets.

The total string set may be denoted by Sn.

Step 204: generating a pinyin hash vector corresponding to the text information based on the index and occurrence number corresponding to each character string element.

In some embodiments, generating the pinyin hash vector corresponding to the text information is as follows.

First, generating a zero vector with a dimension being equal to that of the total string set.

Second, for each character string element among the character string elements, determining a corresponding dimension, in the zero vector, of the index corresponding to the character string element, adjusting a numerical value of the dimension as the occurrence number corresponding to the character string element, and determining the adjusted zero vector as the pinyin hash vector corresponding to the text information.

Step 205: obtaining continuous features corresponding to the text information based on the pinyin hash vector and an embedded neural network.

A specific processing way that the vector is processed by means of the embedded neural network to obtain the continuous features refers to the related art, but is not specifically limited in some embodiments of this disclosure. After obtaining the continuous features corresponding to the text information, the meaning of the text information may be analyzed and classified based on the continuous features.

The text information processing method provided by some embodiments of this disclosure has the advantages in the first embodiment, in addition, the step length and window size of the sliding window may be set by those skilled in the art according to an actual demand when the N-tuple algorithm is used to process the pinyin strings obtained by converting words in the dictionary in a process of generating the total string set, and therefore, the text information processing method is strong in flexibility and capable of meeting demands of different users.

### Third Embodiment

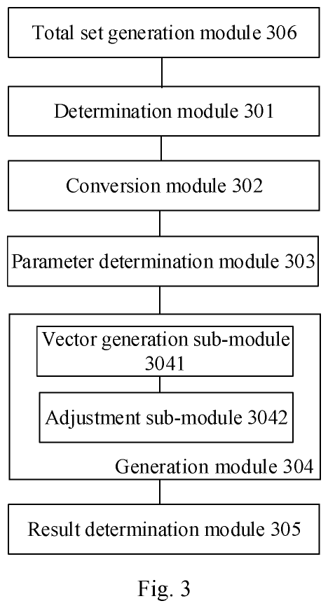

Referring to FIG. 3, a structural block diagram of a text information processing device according to the third embodiment of this disclosure is shown.

The text information processing device provided by some embodiments of this disclosure may include a determination module 301 configured to determine a pinyin string corresponding to text information; a conversion module 302 configured to use an N-tuple algorithm to convert the pinyin string into a string set that includes a plurality of character string elements; a parameter determination module 303 configured to determine an index and the occurrence number, in a total string set, of each character string element in the string set; a generation module 304 configured to generate a pinyin hash vector corresponding to the text information based on the index and occurrence number corresponding to each character string element; and a result determination module 305 configured to obtain continuous features corresponding to the text information based on the pinyin hash vector and an embedded neural network.

In some embodiments, the conversion module 302 is specifically configured to: obtain a string set that includes a plurality of character string elements by using a sliding window algorithm based on the pinyin string and a preset step length and window size from the first character of the pinyin string.

In some embodiments, the device further includes a total set generation module 306 configured to convert words in a dictionary into pinyin strings respectively; generate a character string element by adding placeholders before and after the pinyin string corresponding to each word; use an N-tuple algorithm to convert each character string element into a second string set that includes a plurality of character string elements for each generated character string element; and obtain a total string set by uniting second string sets.

In some embodiments, the generation module 304 may include a vector generation sub-module 3041 configured to generate a zero vector with a dimension being equal to that of the total string set; and an adjustment sub-module 3042 configured to determine a corresponding dimension, in the zero vector, of the index corresponding to each character string element among the character string elements, adjust a numerical value of the dimension as the occurrence number corresponding to the character string element and determine the adjusted zero vector as the pinyin hash vector corresponding to the text information.

The text information processing device in some embodiments of this disclosure is used for implementing the corresponding text information processing methods in the first and second embodiments and has corresponding beneficial effects of the method embodiments, the descriptions thereof are omitted herein.

### Fourth Embodiment

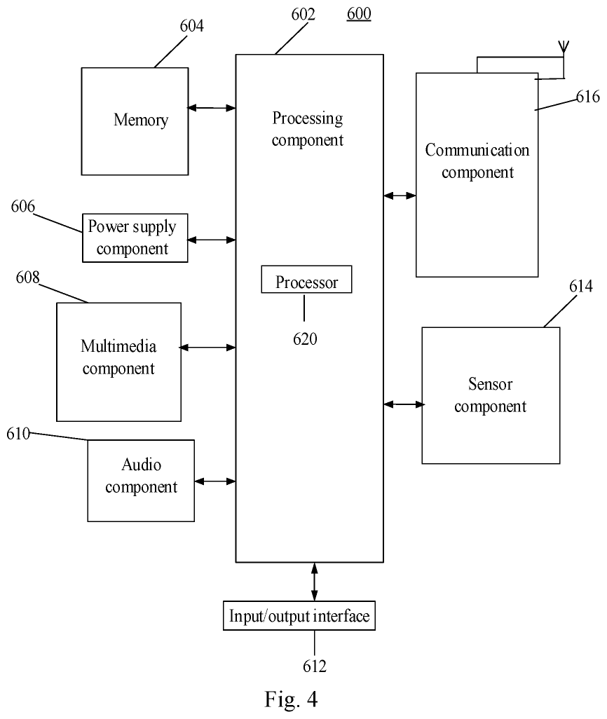

Referring to FIG. 4, a structural block diagram of a terminal for processing text information according to the fourth embodiment of this disclosure is shown.

The terminal in some embodiments of this disclosure may include a memory, a processor and a text information processing program stored on the memory and when the text information processing program is executed by the processor, and the steps of any one of the text information processing methods in this disclosure are implemented.

FIG. 4 is a block diagram of a terminal 600 shown according to an exemplary embodiment. For example, the terminal 600 may be a mobile phone, a computer, a digital broadcasting terminal, a message sending and receiving device, a game console, a tablet device, a medical device, a fitness device, a personal digital assistant and the like.

Referring to FIG. 4, the terminal 600 may include one or more of the following components: a processing component 602, a memory 604, a power supply component 606, a multimedia component 608, an audio component 610, an input/output (I/O) interface 612, a sensor component 614 and a communication component 616.

The processing component 602 generally controls the overall operation of the device 600, such as operations associated with display, telephone calling, data communication, camera operation and recording operation. The processing component 602 may include one or more processors 620 to execute an instruction so as to complete all or parts of steps of the above-mentioned method. In addition, the processing component 602 may include one or more modules facilitating the interaction between the processing component 602 and each of other components. For example, the processing component 602 may include a multimedia module so as to facilitate the interaction between the multimedia component 608 and the processing component 602.

The memory 604 is configured to store various types of data so as to support the operations on the terminal 600. An example of the data includes an instruction, operated on the terminal 600, for any application programs or methods, contact data, telephone directory data, messages, pictures, videos and the like. The memory 604 may be implemented by any types of volatile or non-volatile storage devices or a combination thereof, such as a static random access memory (SRAM), an electrically erasable programmable read only memory (EEPROM), an erasable programmable read only memory (EPROM), a programmable read only memory (PROM), a read only memory (ROM), a magnetic memory, a flash memory, a magnetic disk or an optical disc.

The power supply component 606 provides power for various components of the terminal 600. The power supply component 606 may include a power supply management system, one or more power supplies and other components associated with the generation, management and power distribution of the terminal 600.

The multimedia component 608 includes a screen located between the terminal 600 and a user and provided with an output interface. In some embodiments, the screen may include a liquid crystal display (LCD) and a touch panel (TP). If the screen includes the TP, the screen may be realized as a touch screen so as to receive an input signal from a user. The TP includes one or more touch sensors so as to sense touch, slip and gestures on the TP. The touch sensor not only may sense the boundary of a touch or slip action, but also may detect duration time and pressure related to the touch or slip operation. In some embodiments, the multimedia component 608 includes a front-facing camera and/or a rear-facing camera. When the terminal 600 is in an operating mode such as a shooting mode or a video mode, the front-facing camera and/or a rear-facing camera may receive external multimedia data. Each of the front-facing camera and the rear-facing camera may be a fixed optical lens system or may have focal length and optical zooming capability.

The audio component 610 is configured to output and/or input an audio signal. For example, the audio component 610 includes a microphone (MIC), when the terminal 600 is in the operating mode such as a calling mode, a recording mode and a voice recognition mode, the MIC is configured to receive an external audio signal. The received audio signal may be further stored in the memory 604 and may be transmitted via the communication component 616. In some embodiments, the audio component 610 further includes a loudspeaker for outputting an audio signal.

The I/O interface 612 is provided between the processing component 602 and a peripheral interface module, and the above-mentioned peripheral interface module may be a keyboard, a click wheel, buttons and the like. These buttons may include, but are not limited to a homepage button, a volume button, a start button and a lock button.

The sensor component 614 includes one or more sensors for providing state evaluation on various aspects for the terminal 600. For example, the sensor component 614 may detect an on/off state of the terminal 600 and the relative positioning of the components, for example, the component is used as a display and a keypad of the terminal 600, and the sensor component 614 may also detect the position change of the terminal 600 or one component of the terminal 600, the existence or inexistence of contact between a user and the terminal 600, the orientation or acceleration/deceleration of the terminal 600 and the temperature variation of the terminal 600. The sensor component 614 may include a proximity sensor configured to detect the existence of a nearby object when no any physical contacts exist. The sensor component 614 may further include an optical sensor such as a CMOS or CCD image sensor used in imaging applications. In some embodiments, the sensor component 614 may further include an acceleration sensor, a gyroscope sensor, a magnetic sensor, a pressure sensor or a temperature sensor.

The communication component 616 is configured to facilitate the communication between the terminal 600 and any one of other devices in a wired or wireless way. The terminal 600 may be accessed to a wireless network based on a communication standard, such as a WiFi, 2G or 3G or a combination thereof. In an exemplary embodiment, the communication component 616 receives a broadcast signal or broadcast related information from an external broadcast management system through a broadcast channel. In one exemplary embodiment, the communication component 616 further includes a near-field communication (NFC) module so as to facilitate short-range communication. For example, the NFC module may be realized based on a radio frequency identification (RFID) technology, an infrared data association (IrDA) technology, an ultrawide band (UWB) technology, a Bluetooth (BT) technology and other technologies.

In some embodiments, the terminal 600 may be realized by one or more application specific integrated circuits (ASIC), digital signal processors (DSP), digital signal processing devices (DSPD), programmable logic devices (PLD), field-programmable gate arrays (FPGA), controllers, microcontrollers, microprocessors or other electronic elements and is used for executing the text information processing method. In some embodiments, the text information processing method includes: determining a pinyin string corresponding to text information; using an N-tuple algorithm to convert the pinyin string into a string set that includes a plurality of character string elements; determining an index and the occurrence number, in a total string set, of each character string element in the string set; generating a pinyin hash vector corresponding to the text information based on the index and occurrence number corresponding to each character string element; and obtaining continuous features corresponding to the text information based on the pinyin hash vector and an embedded neural network.

In some embodiments, the step of using an N-tuple algorithm to convert the pinyin string into a string set that includes a plurality of character string elements includes: obtaining a string set that includes a plurality of character string elements by using a sliding window algorithm based on the pinyin string and a preset step length and window size from the first character of the pinyin string.

In some embodiments, the total string set is generated in a way as follows: converting words in a dictionary into pinyin strings respectively; generating a character string element by adding placeholders before and after the pinyin string corresponding to each word; using an N-tuple algorithm to convert each character string element into a second string set that includes a plurality of character string elements for each generated character string element; and obtaining a total string set by uniting second string sets obtained by conversion.

In some embodiments, the step of generating a pinyin hash vector corresponding to the text information based on the index and occurrence number corresponding to each character string element includes: generating a zero vector with a dimension being equal to that of the total string set; and determining a corresponding dimension, in the zero vector, of the index corresponding to each character string element among the character string elements, adjusting a numerical value of the dimension as the occurrence number corresponding to the character string element, and determining the adjusted zero vector as a pinyin hash vector corresponding to the text information.

Some embodiments of the disclosure further provide a non-transitory computer readable storage medium including an instruction, such as a memory 604 including an instruction, the above-mentioned instruction may be executed by the processor 620 of the terminal 600 so as to complete the above-mentioned text information processing method. For example, the non-transitory computer readable storage medium may be an ROM, a random access memory (RAM), a CD-ROM, a magnetic tape, a floppy disk, an optical data storage device and the like. When the instruction in the storage medium is executed by the processor of the terminal, the terminal may execute the steps of any one of the text information processing methods in this disclosure.

According to the terminal provided by some embodiments of this disclosure, the words in the dictionary are converted into the pinyin strings, and the N-tuple algorithm is used to process the pinyin strings to obtain a pinyin hash space corresponding to the total string set. Then, the text information is converted into the pinyin string, the pinyin hash vector corresponding to the pinyin string is determined based on the constructed pinyin hash space, and finally, the determined pinyin hash vector is processed by means of the embedded neural network to obtain the continuous features corresponding to the text information. Since the pinyin hash space is adopted to characterize the words in the dictionary in some embodiments of this disclosure, there is good robustness for words that do not appear in the dictionary; in addition, since the size of the pinyin hash space is constant, an overall structure of the constructed pinyin hash space may not be affected even if words are newly added in the dictionary, pinyin string sets corresponding to the newly added words are only required to be added, and therefore, strong expandability is achieved.

Some embodiments of this disclosure further provide an application program, and the application program is used for executing the steps of any one of the text information processing methods in this application at run time.

According to the terminal provided by some embodiments of this disclosure, the words in the dictionary are converted into the pinyin strings, and the N-tuple algorithm is used to process the pinyin strings to obtain a pinyin hash space corresponding to the total string set. Then, the text information is converted into the pinyin string, the pinyin hash vector corresponding to the pinyin string is determined based on the constructed pinyin hash space, and finally, the determined pinyin hash vector is processed by means of the embedded neural network to obtain the continuous features corresponding to the text information. Since the pinyin hash space is adopted to characterize the words in the dictionary in some embodiments of this disclosure, there is good robustness for words that do not appear in the dictionary; in addition, since the size of the pinyin hash space is constant, an overall structure of the constructed pinyin hash space may not be affected even if words are newly added in the dictionary, pinyin string sets corresponding to the newly added words are only required to be added, and therefore, strong expandability is achieved.

With regard to the device embodiments, the description of the device embodiments is relatively simple due to basic similarity of the device embodiments to the method embodiments, and therefore, correlations thereof may refer to partial descriptions of the method embodiments.

The text information processing solution provided herein is not inherently related to any specific computers, virtual systems or other devices. Various universal systems may also be used together with demonstration based on this. According to the above description, it is apparent to construct a structure required by a system having the solution of this disclosure. In addition, this disclosure is not specific to any specific programming languages. It should be understood that the content of this disclosure described herein may be realized by means of various programming languages, and the specific languages are described above in order to disclose the optimal implementation way of this disclosure.

A great number of specific details are described in the specification provided herein. However, it can be understood that some embodiments of this disclosure can be put into practice under the condition that these specific details are not provided. In some embodiments, known methods, structures and technologies are not shown in detail so as not to obscure the understanding of the specification.

Similarly, it should be understood that, in the description of the above exemplary embodiments of this disclosure, all features in this disclosure are grouped into single embodiment, figure or description thereof sometimes in order to simplify the present disclosure and help the understanding of one or more of all the aspects of this disclosure. However, the disclosed method should not be explained to reflect the following intension: namely this disclosure required to be protected requires more features than those clearly recorded in each claim. Or rather, as reflected by the claims, the features are less than all the features of the aforementioned single embodiment on the disclosure aspect. Therefore, the claims following the detailed descriptions are clearly incorporated into the detailed descriptions herein, wherein each claim is used as a separate embodiment of this disclosure.

It can be understood by those skilled in the art that the modules in the device in some embodiments can be adaptively changed and arranged in one or more devices different from those in some embodiments. The modules or units or components in some embodiments can be combined into one module or unit or component, in addition, they can also be divided into a plurality of sub-modules or sub-units or sub-components. Except that at least some of such features and/or processes or units are mutually exclusive, all the features disclosed in the specification (including appended claims, abstract and accompanying drawings) and all the processes or units of any methods or devices disclosed in such a way can be combined by adopting any combinations. Unless otherwise stated clearly, each feature disclosed in the specification (including appended claims, abstract and accompanying drawings) can be replaced with alternative features providing the same, equal or similar purposes.

In addition, it can be understood by those skilled in the art that although some embodiments described herein include certain features included in other embodiments, rather than other features, the combinations of the features in the different embodiments mean that some embodiments fall within the scope of this disclosure and form different embodiments. For example, in the claims, any one of embodiments required to be protected can be used in any combination ways.

Some embodiments of each component in this disclosure can be implemented by hardware or a software module running on one or more processors or combinations thereof. It should be understood by those skilled in the art that some or all functions of some or all components in the text information processing solution according to some embodiments of this disclosure can be achieved by using a microprocessor or a digital signal processor (DSP) in practice. This disclosure can also be implemented to execute a part of or all devices or device programs (such as a computer program and a computer program product) of the method described herein. Such program for implementing this disclosure can be stored on a computer readable medium or can be provided with one or more signal forms. Such signals can be downloaded from an internet website or provided by carrier signals or provided in any other forms.

It should be noted that the above-mentioned embodiments are intended to describe this disclosure, rather than to limit this disclosure, and alternative embodiments can be designed by those skilled in the art without departing from the scope of the appended claims. In the claims, any reference symbols located between brackets should not be constructed as limitations to the claims. A word “include” does not exclude elements or steps not listed in the claims. The word “a” or “an” preceding the element does not exclude the existence of more elements. This disclosure can be implemented by means of hardware including a plurality of different elements and an appropriately programmed computer. In claims of a unit in which a plurality of devices are listed, a plurality of these devices can be specifically embodied by the same hardware item. Words “first”, “second” and “third” do not denote any order. These words can be explained as names.

What is claimed is:

1. A method for processing text information, wherein the method comprises:
determining a first pinyin string corresponding to text information;
determining a first string set based on the first pinyin string, wherein the first string set comprises a plurality of first string elements;
determining an index and an occurrence number of each first string element in a total string set;
generating a pinyin hash vector based on the index and the occurrence number; and
determining continuous features of the text information based on the pinyin hash vector and an embedded neural network.

2. The method according to claim 1, wherein said determining the first string set, comprises:
determining the first string set by using a sliding window algorithm based on the first pinyin string, wherein the sliding window algorithm comprises a preset step length and a window size.

3. The method according to claim 1, wherein the method further comprise:
determining second pinyin strings of words in a dictionary;
generating a second string element by adding placeholders before and after a second pinyin string for each of the words respectively;
determining a second string set based on the second string element; and
generating the total string set by uniting second string sets.

4. The method according to claim 1, wherein said generating a pinyin hash vector, comprises:
generating a zero vector, wherein a dimension of the zero vector is equal to that of the total string set;
determining a dimension of the index in the zero vector;
generating the pinyin hash vector by adjusting a numerical value of the dimension as the occurrence number.

5. A terminal, comprising a memory, a processor and a program for processing text information, wherein the program is stored on the memory, the processor is configured to execute the program to implement followings;
determining a first pinyin string corresponding to text information;
determining a first string set based on the first pinyin string, wherein the first string set comprises a plurality of first string elements;
determining an index and an occurrence number, in a total string set, of each first string element;
generating a pinyin hash vector based on the index and the occurrence number; and
determining continuous features of the text information based on the pinyin hash vector and an embedded neural network.

6. The terminal according to claim 5, wherein the processor is configured to execute the program to determine the first string set by:
determining the first string set by using a sliding window algorithm based on the first pinyin string, wherein the sliding window algorithm comprises a preset step length and a window size.

7. The terminal according to claim 5, wherein the processor is configured to execute the program to generate the total string set by:
determining second pinyin strings of words in a dictionary;
generating a second string element by adding placeholders before and after a second pinyin string for each of the words respectively;
determining a second string set based on the second string element; and
generating the total string set by uniting second string sets.

8. The terminal according to claim 5, wherein the processor is configured to execute the program to generate a pinyin hash vector by:
generating a zero vector, wherein a dimension of the zero vector is equal to that of the total string set,
determining a dimension, in the zero vector, of the index,
generating the pinyin hash vector by adjusting a numerical value of the dimension as the occurrence number.

9. A computer readable storage medium, wherein the computer readable storage medium stores a program for processing text information, the program comprising sets of instructions for:
determining a first pinyin string corresponding to text information;
determining a first string set based on the first pinyin string, wherein the first string set comprises a plurality of first string elements;
determining an index and an occurrence number of each first string element in a total string set;
generating a pinyin hash vector based on the index and the occurrence number; and
determining continuous features of the text information based on the pinyin hash vector and an embedded neural network.

10. The computer readable storage medium according to claim 9, wherein said determining the first string set, comprises:
determining the first string set by using a sliding window algorithm based on the first pinyin string, wherein the sliding window algorithm comprises a preset step length and a window size.

11. The computer readable storage medium according to claim 9, wherein the program further comprises a set of instructions for:
determining second pinyin strings of words in a dictionary;
generating a second string element by adding placeholders before and after a second pinyin string for each of the words respectively;
determining a second string set based on the second string element; and
generating the total string set by uniting second string sets.

12. The computer readable storage medium according to claim 9, wherein said generating a pinyin hash vector, comprises:
generating a zero vector, wherein a dimension of the zero vector is equal to that of the total string set;
determining a dimension of the index in the zero vector;
generating the pinyin hash vector by adjusting a numerical value of the dimension as the occurrence number.
